(19) United States
(12) Patent Application Publication
(10) Pub. No.: US 2016/0018316 A1
(43) Pub. Date: Jan. 21, 2016

(54) INSPECTION WINDOW

(71) Applicants: Timothy ROHRER, Pittsford, NY (US); William J. WEST, Victor, NY (US)

(72) Inventors: Timothy M. Rohrer, Pittsford, NY (US); William J. West, Victor, NY (US)

(21) Appl. No.: 14/440,027

(22) PCT Filed: Oct. 30, 2013
(86) PCT No.: PCT/US13/67533

§ 371 Date: Apr. 30, 2015

Related U.S. Application Data
(60) Provisional application No. 61/720,318, filed on Oct. 30, 2012.

(51) Int. Cl. G01N 21/01; G01J 5/08; G02B 27/00

(52) U.S. Cl. CPC G01N 21/01; G02B 27/0006; G01J 5/0875; G01N 2201/068; G01J 2005/0077

(57) ABSTRACT

An apparatus comprises an optical pane transparent to infrared radiation. The pane includes first and second sides, a periphery, and a retention region. A frame defines an opening that can accept the pane and includes a pane retention region. Additionally, a retainer is configured to secure the optical pane in the opening and includes a retaining surface mated to the pane support surface of the frame and configured to support the optical pane at the retention region. The pane, frame and retainer are configured to have mating features which can include a bead, a retaining ridge, a labyrinth configuration and protrusions, recesses, channels, or steps or a combination of these features.

### TECHNICAL FIELD

The devices and methods described below relate generally to the field of inspection and safety devices and more particularly to observation windows.

### BACKGROUND

Many types of industrial equipment, including electrical equipment, need to be periodically inspected as part of efforts to keep workers and facilities safe. This equipment can often be located behind various shields or located within various types of enclosures to prevent physical access to the equipment The use of shields and enclosures may be required by various standards, codes, or regulations. Typically, these shields and enclosures can also hinder inspection efforts.

One manner of performing an inspection of this equipment is infrared inspection. Infrared inspection can be performed using some type of measurement, tool such as an infrared camera or a thermal imaging device. Commonly, shields and enclosures of electrical equipment can also block transmission of infrared radiation and impede inspection efforts that use infrared radiation. In many cases, a shield must be removed or an enclosure opened in order to perform an infrared or thermal inspection. Removal of shields and opening of enclosures can increase risk of injury to workers and damage to physical facilities.

Windows can be placed in shields and walls of enclosures to aid inspection efforts. When infrared examination or thermal imaging is conducted through a window, the window can be constructed to be completely or almost completely transparent, or at least translucent, to the transmission of electromagnetic radiators at a specified wavelength or over a range of wavelengths, including a wavelength or range of wavelengths at the infrared end of the spectrum. Use of these types of windows for inspection efforts can sometimes permit inspections to occur without removal of shields or opening of enclosures.

### BRIEF DESCRIPTION OF THE DRAWINGS

The devices and methods discussed below are described with reference to the accompanying drawings, in which the same numbers in each drawing refer to the same components. The accompanying drawings are described as follows:

FIG. 1 is an exploded perspective view of an observation window set in a wall.

FIG. 2 is a perspective view of the assembled window of FIG. 1 also depicting a hinged cover shown in an open position.

FIG. 3 is a top view of the window as shown in FIG. 2, taken along the line A-A of FIG. 2, and showing the window installed on a wall.

FIG. 4 is a perspective view of the window of FIG. 1 also depicting a hinged cover shown in a closed position; and installed on a wall of an obstruction.

FIG. 5 is a vertical cross-sectional view of the window of FIG. 1 taken along the line A-A of FIG. 3.

FIG. 6 is an exploded cross-sectional view showing details of portions of the view of FIG. 4.

FIG. 7A is a detailed assembled vertical cross-section view of the bezel, pane, frame, and studs of the window of FIG. 3.

FIG. 7B is a more detailed assembled vertical cross-section view of the bezel, pane, frame, and studs of the portion of the window contained in ellipse 6B of FIG. 6A.

FIG. 7C is a detailed assembled cross section view displaying an example of an optic with a bead.

FIG. 7D is a detailed assembled cross section view displaying an example of a retaining ridge.

FIG. 7E is detailed assembled cross section view displaying another example of a retaining ridge.

FIG. 7F is a detailed assembled cross section view displaying an example of an optic with a retaining ridge and a bead.

FIG. 7G is a detailed assembled cross section view displaying an example of an optic with a bead and a labyrinth.

FIG. 8 is an exploded, cross-sectional view of the optical pane, the frame, and the retaining bezel along with fasteners and a safety guard.

FIG. 9 is a plan view of a safety guard.

### SUMMARY

In one example, an apparatus comprises an optical pane that is transparent to infrared radiation and including first and second sides, a periphery, and first and second retention regions positioned near the periphery of the optical pane. A frame can define an opening that can accept the optical pane and can include a pane retention region. The pane retention region can include a first pane support surface configured to support the optical pane at the first side of the first retention region and a second pane support surface configured to support the optical pane at the first side of the second retention region. A retaining bead can be configured to secure the optical pane in the opening and can include a first retaining surface mated to the first pane support surface of the frame and configured to support the optical pane at the second side of the first retention region, and a second retaining surface mated to the second pane support surface of the frame and configured to support the optical pane at the second side of the second retention region.

The apparatus can further comprise a movable cover configured to prevent access to the optical pane in a closed position and permit access to the optical pane in an open position. The cover can be movably attached to the frame by a hinge and the hinge can be a floating hinge. The apparatus can further comprise retaining bolts configured to secure the cover in the closed position. The apparatus can still further comprise a guard configured to prevent passage of a human body part through the opening of the frame.

The optical pane can be formed from polyethylene or a crystalline material. The optical pane can be formed from a material that is transparent to infrared radiation that is selected from the group consisting of high-density polyethylene, calcium fluoride, barium fluoride, zinc selenide, and silica glass. The infrared radiation can have a wavelength in the range of about 1 micron to about 5 microns, in the range of about 1.4 microns to about 3 microns, or in the range of about 8 microns to about 14 microns.

### DETAILED DESCRIPTION

The devices and methods disclosed in this document are described with reference to the accompanying drawings. The description below, along with the accompanying drawings, depicts various examples of how to make and use such devices and methods. This description provides a number of examples intended to help explain. The examples are not exhaustive. Variations and modifications may be, and are expected to be, made to these examples. Those people having an ordinary level of skill in this area will observe after reading the material below that such variations and modifications may be made without departing from the general scope of the subject matter described.

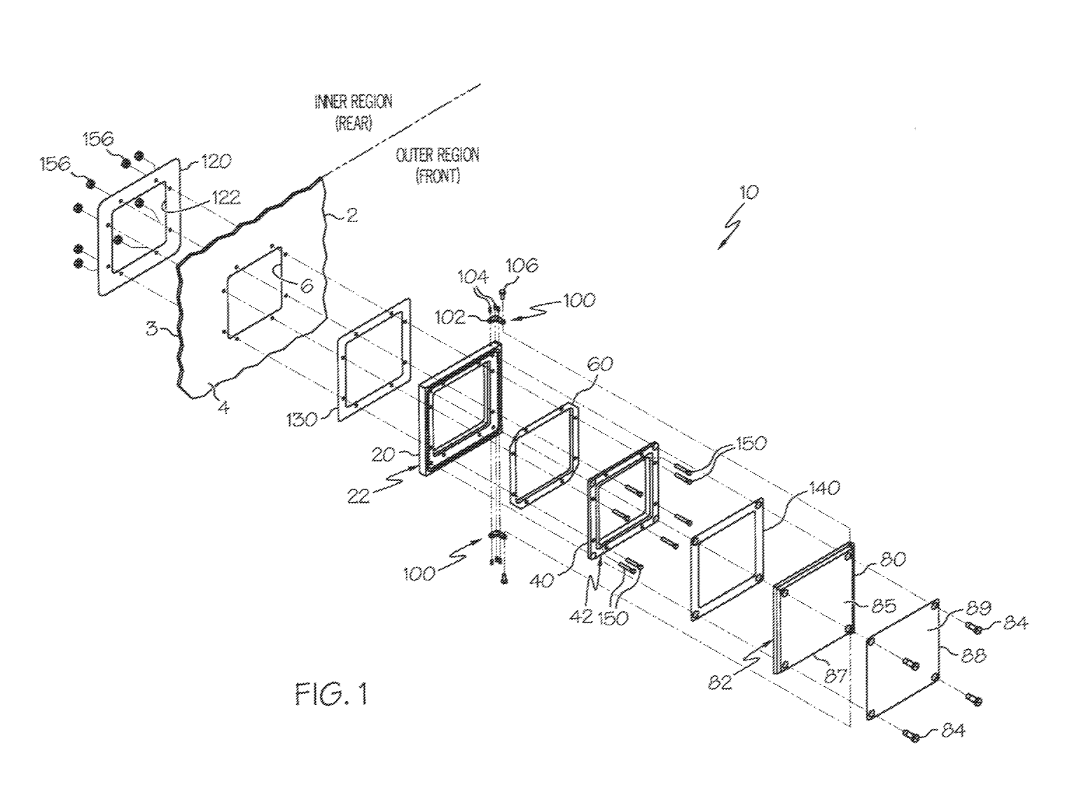

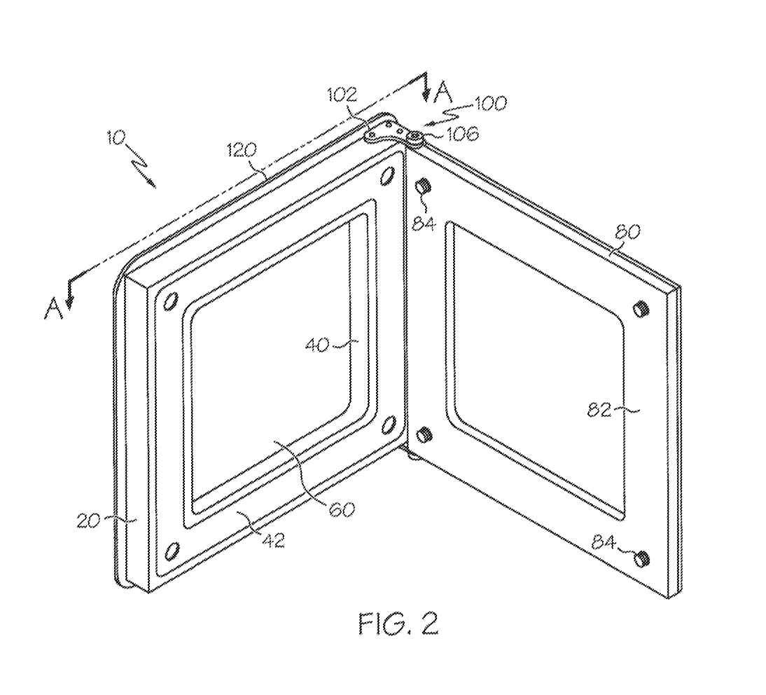

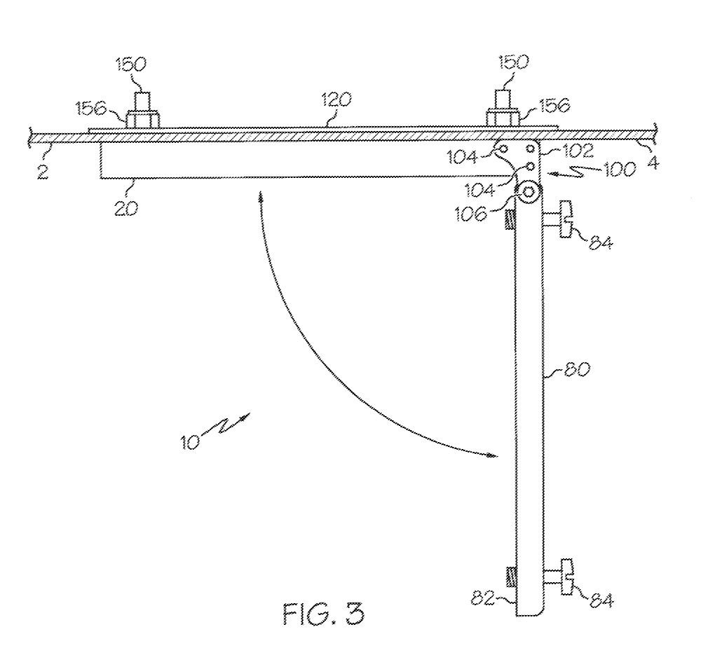

The description below sometimes describes certain components with directional adjectives such as “forward,” “rearward,” “inner,” “outer,” “top,” “upper,” “bottom,” “lower,” “left,” or “right,” among others. These directional adjectives are provided to assist in describing the orientation of structures pictured in the accompanying figures when those figures are positioned such that the figure indicator (for example, FIG. 1, FIG. 2, and so forth) is oriented horizontally and readable from left to right in the manner of reading text written in the English language. People having an ordinary level of skill in this area will readily recognize from this description however that the devices described below need not be used in the same orientation as pictured or described below but instead can be used in other orientations.

The devices and methods described below can be used to perform infrared or thermal inspections of electrical equipment or other equipment. Although the specific examples discussed below will focus on examinations of electrical equipment for ease of explanation and readability, various alterations, adaptions, and modifications, including alterations, adaptions or modifications specifically described below, can be made to enable the devices and methods to be used for other types of inspections.

Within the context of inspections of electrical equipment, such inspections generally can be performed by searching for electrical components that are generating heat in excess of what may typically be expected from those components during normal operation. Heat generation of this type can be an indication that a component is about to fail and must be replaced. Heat generated by an electrical component about to fail can be radiated as energy in the infrared range of the electromagnetic spectrum (“IR energy”). Devices that can detect IR energy, such as infrared cameras or thermal imagers can be used to perform visual inspections of components and identify those components that may be about to fail.

To facilitate inspections using infrared cameras or thermal imagers, a window can be placed in a wall of a shield or enclosure. Typically, surfaces of shield or enclosure walls are generally planar. Although the examples shown and described focus on planar walls, it should be noted that walls can be curved or have irregularities such as protrusions, among other things, and that a window can be adapted to conform to shapes of walls and irregularities of walls. Also, although the window shown is generally square, a window such as the one described can also be other shapes, including generally rectangular, trapezoidal, polygonal, oval, circular, ellipsoidal, or another desired shape.

FIG. 1 is an exploded perspective view of an observation window 10 set in a wall 2. it should be noted that the wall 2 can be part of a shield or enclosure separate and apart from the observation window 10. A shield or enclosure assembly can also be created with the observation window 10 preassembled as part of the shield or enclosure.

The observation window 10 can include a frame 20. The frame 20 can be shaped to generally define an overall general shape of the observation window 10. The observation window 10 can also include a retaining bezel 40 and an optical pane 60. The observation window 10 can also include a cover 80 that can optionally be joined to the frame 20 by hinges 100. The observation window 10 can also include a backing plate 120 that can be disposed on an inner side 3 of the wall 2.

Components of the observation window, including the frame 20, the retaining bezel 40, and the backing plate 120, can be sized such that those components extend peripherally a substantial distance from the periphery of the frame 20 to provide additional structural support in the event of an explosion. The exact dimensions of the components will depend on details of each specific implementation. Specifically, the size of the opening 6 of the wall 2, properties of the specific materials used, and desired amount of resistance to potential explosive forces that may be possible can affect dimensions of components of the frame assembly of the observation window 10, as well as the optical pane 60 and other components.

A first gasket 130 can be disposed between an outer side 4 of the wall 2 and a rearward surface 22 of the frame 20 and can provide a seal between the frame 20 and the wad 2. A second gasket 140 can be disposed between a forward surface 42 of the retainer bezel 40 and a rearward surface 82 of the cover 80. The second gasket 140 can provide a seal between the cover 80 and the retaining bezel 40 when the cover 80 is in a closed position and optionally secured against the retaining bezel 40. For illustration simplicity, the gaskets 130 and 140 are only shown in FIG. 1.

A trout surface 85 of the cover 80 can include a recess 87, in which an insert 88 that can be affixed to the cover 80 by one or more fasteners 84. Fasteners 84 are shown in the figures as screws, but other types of threaded or non-threaded fasteners can also be used, including rivets. Additionally or alternatively, the insert 88 can be affixed to the cover 80 using a glue or bonding agent, by welding, or by another appropriate process.

The insert 88 can have various information or indicia on its outer surface 89. This information or indicia can include such things as a logo, safety label, or instructions, among other things. Additionally or alternatively, another means of presenting information or indicia can be used. These other means can include painting, labeling or etching, among others, and can be placed directly on the front surface 85 of the cover 80 as well as on the outer surface 89 of the insert 88. Additionally or alternatively, indicia or information can be presented on the rearward surface 82 of the cover 80.

The optical pane 60 can be created front an appropriate material that satisfies design requirements for a particular application. For example, when infrared inspections are to be performed, the optical pane 60 can be created using a material that is transparent to one or more wavelengths in the infrared range of the electromagnetic radiation spectrum. It should be noted that the term “transparent” as used here includes an entire range of degrees of transparency from completely transparent up to, but not including completely opaque. Suitable materials that can be used to form the optical pane 60 include high-density polyethylene (“HDPE”), PolyIR® 1 and PolyIR® 2, available from Fresnel Technologies, Inc., various crystalline materials such as calcium fluoride, barium fluoride, and zinc selenide, among others, various types of silica glass, and other suitable materials. Specifically, suitable materials include those that are transparent to infrared radiation in ranges of about 1 to about 5 microns, particularly including a range of about 1.4 to about 3 microns, and about 8 to about 14 microns.

In an example, the optical pane 60 can be formed with a step at its perimeter to correspond with steps of the frame 20 and the retaining bezel 40. When the frame 20 and retainer bezel 40 are joined to each other with the optical pane 60 between them, the step of the optical pane 60 can be secured in a labyrinth defined by the steps of the retaining bezel 40 and the frame 20.

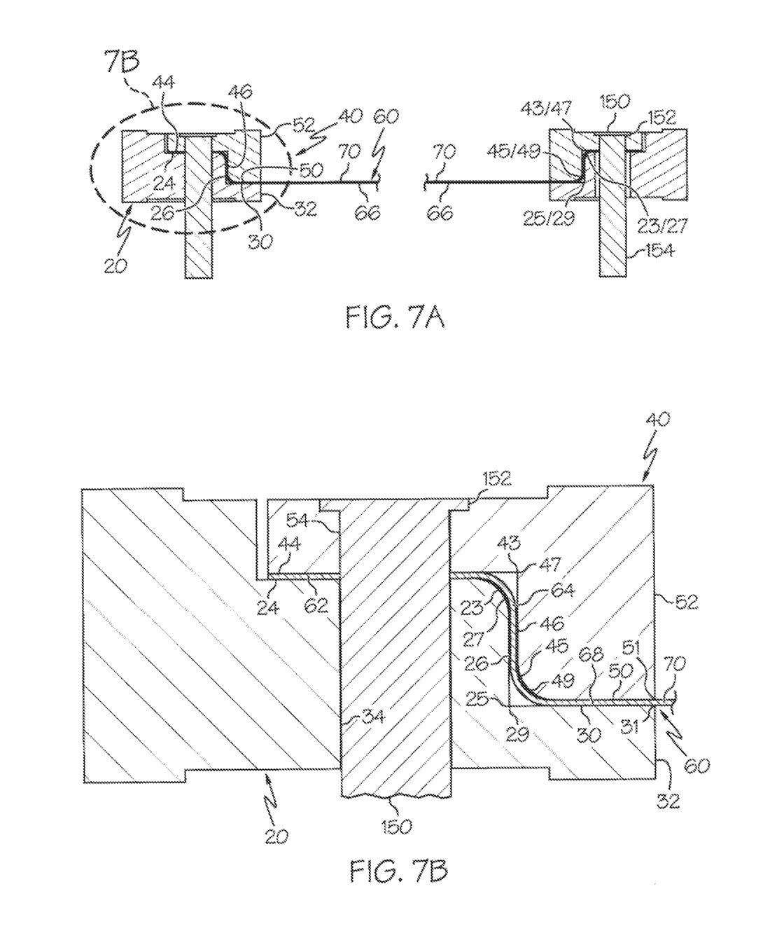

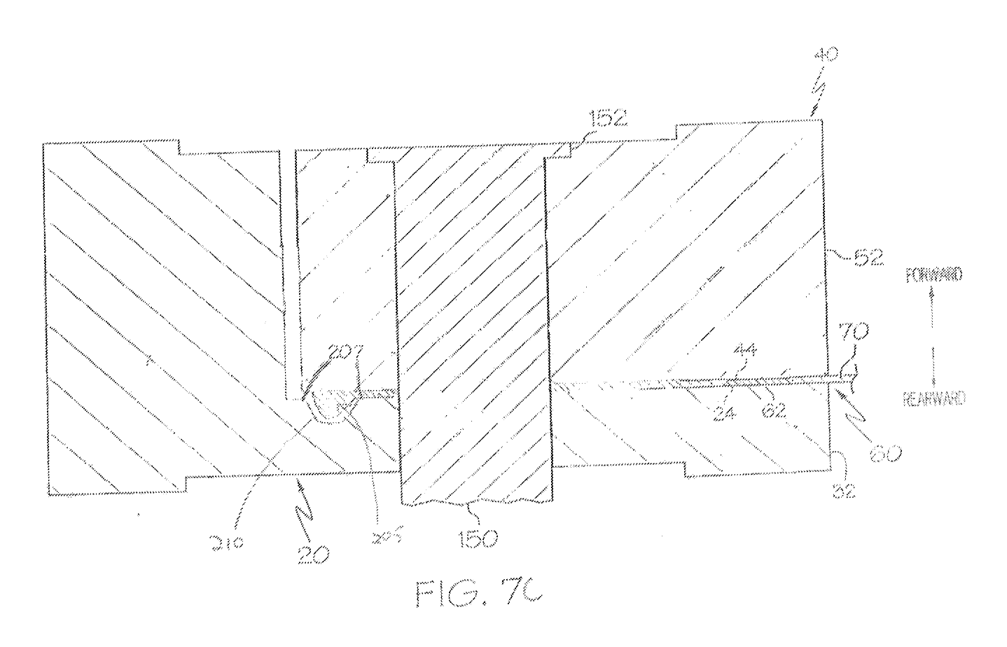

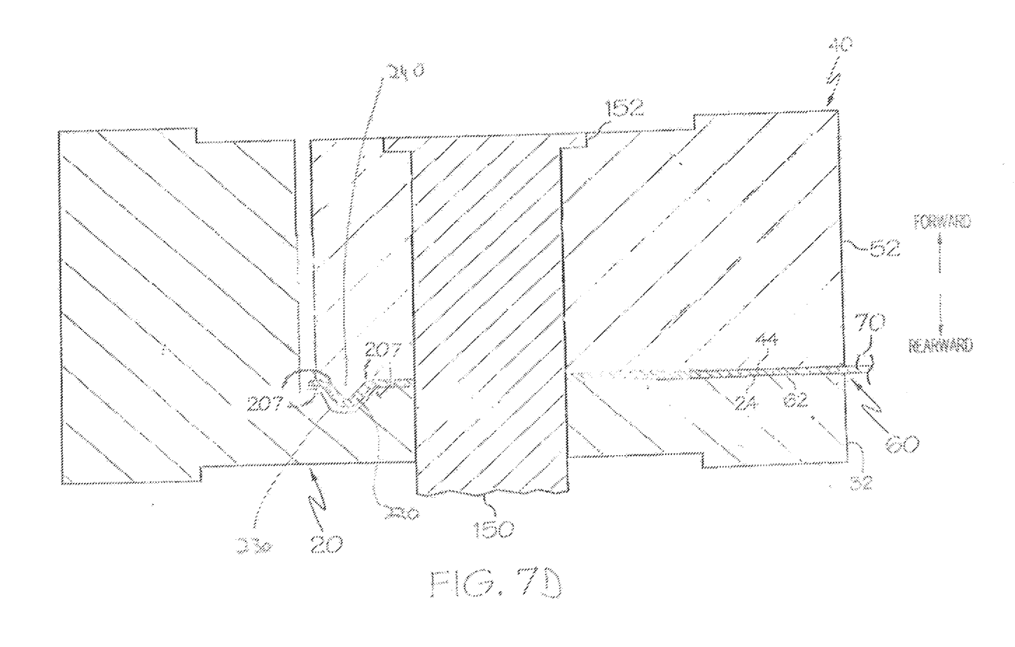

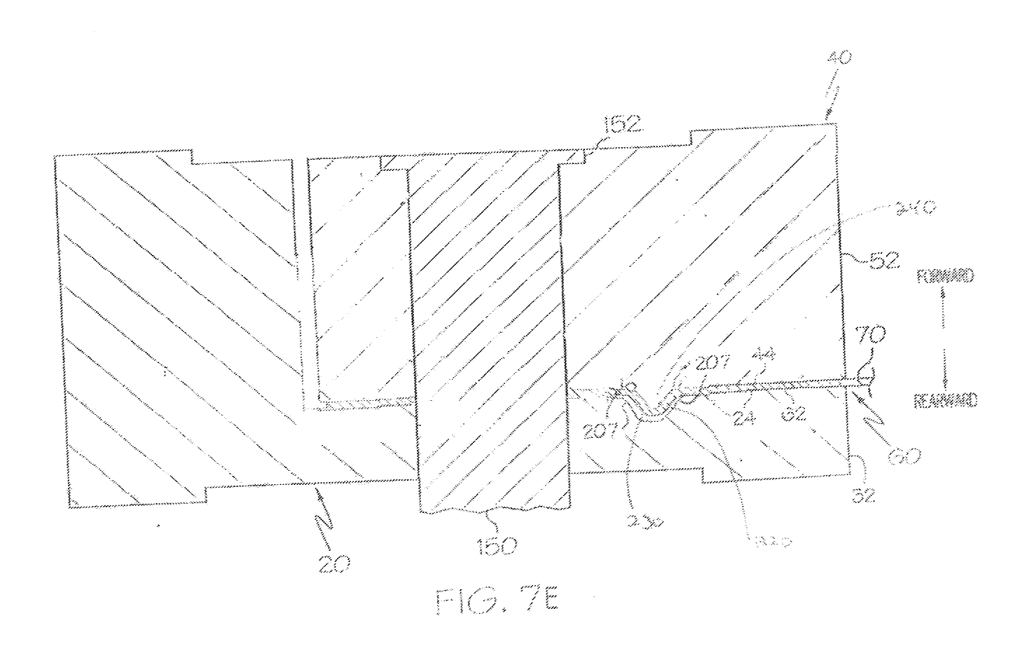

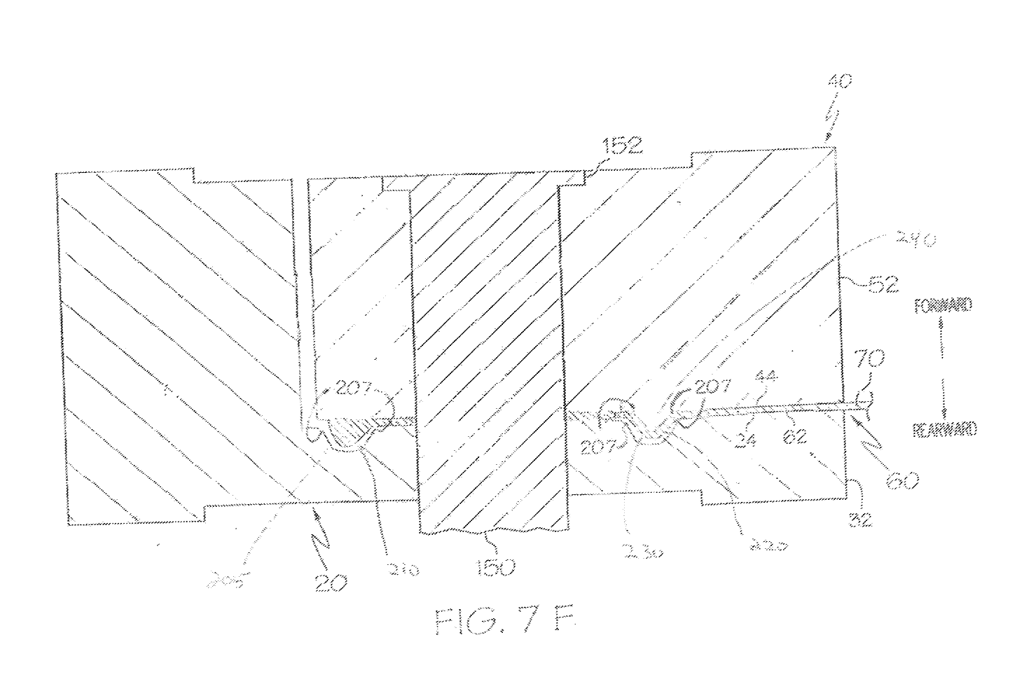

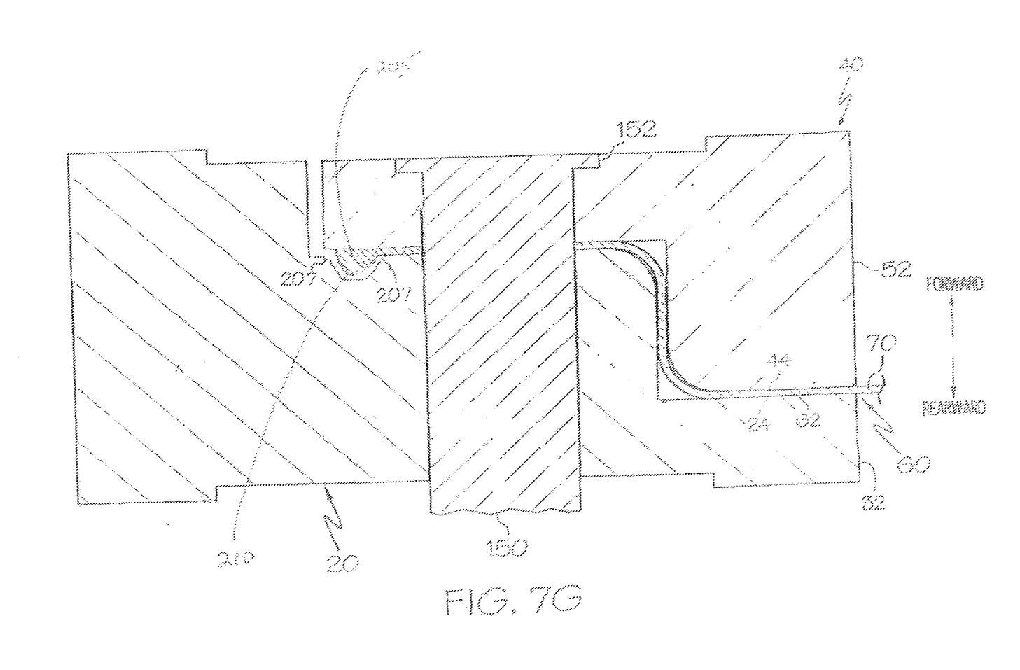

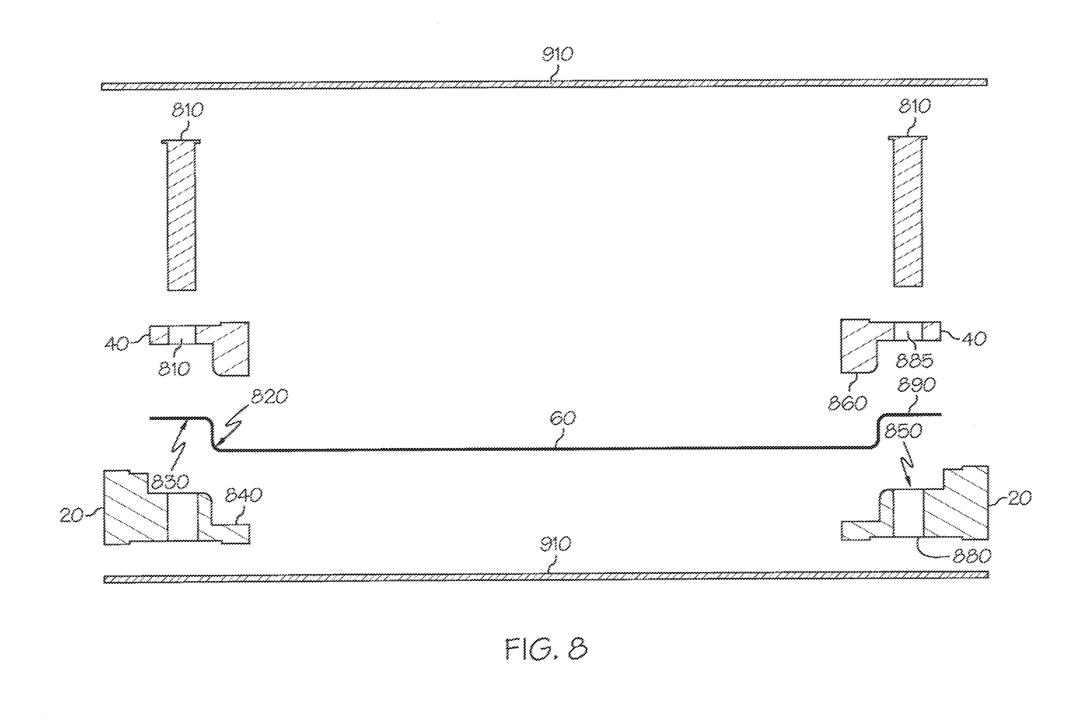

The frame 20 of the observation window 10 can include a first forward facing surface 24, a frame step 26, and a second forward facing surface 30. The frame step 26 can include a rearward perimeter 25, and a forward perimeter 27 that can be contiguous with an inner perimeter 23 of the first forward facing surface 24. A radiused transition can be provided at the contiguous perimeters 23 and 27 as shown in FIG. 7B, so that when the frame 20 contacts the optical pane 60, the optical pane 60 will be less likely to endure stress or cutting forces at that location. The second forward facing surface 30 can include an outer perimeter 29 contiguous with the rearward perimeter 25 of the frame step 26, and an inner perimeter 31 defining a frame central opening 32.

The retaining bezel 40 can be joined to the frame 20, and can include a first rearward facing surface 44, a bezel step 46, and a second rearward facing surface 50. The bezel step 46 can include a rearward perimeter 45, and a forward perimeter 47 contiguous with an inner perimeter 43 of the first rearward facing surface 44. The second rearward facing surface 50 can include an outer perimeter 49 contiguous with the rearward perimeter 45 of the bezel step 46, and an inner perimeter 51 defining a bezel central opening 52. A radiused transition can be provided at the contiguous perimeters 49 and 45 as shown in FIG. 7B.

The optical pane 60 can include an outer flange portion 62, a step portion 64, and a transparent central portion 66. The outer flange portion 62 can be disposed between the first forward facing surface 24 of the frame 20 and the first rearward facing surface 44 of the retaining bezel 40. The step portion 64 can be disposed between the frame step 26 and the retaining bezel step 46. The transparent central portion 66 can include art outer region 68 disposed between the second forward facing surface 30 of the frame 20 and the second rearward facing surface 50 of the retaining bezel 40, and an inner region 70 bounded by at least one of the frame central opening 32 and the bezel central opening 52. The frame central opening 32 and the bezel central opening 52 can be approximately the same size and similarly shaped and can be substantially aligned with each other.

The observation window 10 can include an optical pane 60 that does not include an outer flange 62. In such a configuration, the window frame 20 can include a frame step 26 having a rearward perimeter 25 and a forward perimeter 27, and a forward facing surface 30 having an outer perimeter 29 contiguous with the rearward perimeter 25 of the frame step 26 and an inner perimeter 31 that can define a frame central opening 32. The retaining bezel 40 can be joined to tire frame 20 and can include a bezel step 46 having a rearward perimeter 45 and a forward perimeter 47, and a rearward facing surface 50 having an outer perimeter 49 contiguous with the rearward perimeter 45 of the bezel step 46, and an inner perimeter 51 defining a bezel central opening 52. The optical pane 60 can include a step portion 64 that can be disposed between the frame step 26 and the bezel step 46, and a transparent central portion 66 including an outer region 68 that can be disposed between the forward facing surface 30 of the frame 20 and the rearward facing surface 50 of the retaining bezel 40. An inner region 70 of the optical pane 60 can be bounded by at least one of the frame central opening and the bezel central opening 52.

In other examples, the observation window 10 can also be constructed using a flat configuration held by pins, or a configuration that was formed so that the outer edges of the optical pane 60 formed around a ring or doubled hack over a retaining ridge to similarly trap the edge in a labyrinth. For example, see FIG. 7C through 7F.

In another example, the optical pane 60 can be formed with a bead 205 on the rearward facing side (with relation to the orientation shown in FIGS. 7C, 7F and 7G) located at or near the periphery in the retention region. In some examples, the bead can be hollow (not shown). In some examples, the head can be formed by curling the edge (not shown) of the optical pane 60. In such examples, the corresponding configuration of frame 20 can have a channel 210 to accept the bead 205. When the frame 20 and retainer bezel 40 are joined to each other with the optical pace 60 between them, the bead 205 of the optical pane 60 can be positioned in the channel 210 of the frame 20. Radiused transitions 207 can be provided at the channel 210 as shown in FIG. 7C. The retaining bezel 40 can be joined to the frame 20, and can include a bezel central opening 52. The optical pane 60 can include an outer flange portion 62 and a transparent central portion 66 (not shown). The outer flange portion 62 can be disposed between a forward facing surface 24 of the frame 20 and a rearward lacing surface 44 of the retaining bezel 40. The transparent central portion 66 (not shown) can be bounded by at least one of the frame central opening 32 and the bezel central opening 52. The frame central opening 32 and the bezel central opening 52 can be approximately the same size and similarly shaped and can be substantially aligned with each other.

In an example (not shown), the bead may be both rearward facing and forward facing. In another example (not shown), the bead may be forward facing. In such examples, the retaining bezel can be configured with a channel similar to channel 210 as discussed herein.

In another example, the optical pane 60 can formed with a retaining ridge 220 near its perimeter located in a retention region of the optical pane 60 and located to correspond with a recess 230 of the frame 20 and a protrusion 240 of the retaining bezel 40. The retaining ridge 220 may be located similarly as an example of a bead so as to ease manufacturing of frame 20, as shown in FIG. 7D (recess 230 may be substantially similar to channel 210 of FIG. 7C), or the retaining ridge 220 may be located elsewhere in the retention region of the optical pane 60, as shown in FIG. 7E. In these examples, the configuration of frame 20 and retaining bezel 40 has corresponding receiving and protruding features located to accept and retain the optical pane 60 at the retaining ridge 220. When the frame 20 and retainer bezel 40 are joined to each other with the optical panel 60 between them, the retaining ridge 220 of the optical pane 60 can be disposed between the recess 230 and protrusion 240 defined by the retaining bezel 40 and the frame 20. The optical pane 60 can include an outer flange portion 62 and a transparent central portion 66 (not shown). The outer flange portion 62 can be disposed between a forward facing surface 24 of the frame 20 and a rearward facing surface 44 of the retaining bezel 40. The transparent central portion 66 (not shown) can be bounded by at least one of the frame central opening 32 and the bezel central opening 52. The frame central opening 32 and the bezel central opening 52 can be approximately the same size and similarly shaped and can be substantially aligned with each other. The protrusion 240 of retainer bezel 40 and the lip of the recess 230 of the frame 20 can have radiused transitions 207.

Other examples may include combinations of these features, such as a retaining ridge 220 with a bead 205 as shown in FIG. 7F, or a labyrinth configuration with a bead 205 as shown in FIG. 7G, or a labyrinth configuration with a retaining ridge with or without a bead (not shown). In such combinations, the optical pane 60 can be formed with salient features as bead, retaining ridge or step at its retention region to correspond to configurations of frame 20 and retaining bezel 40 that are likewise configured with protrusions, recesses, channels, or steps as described herein.

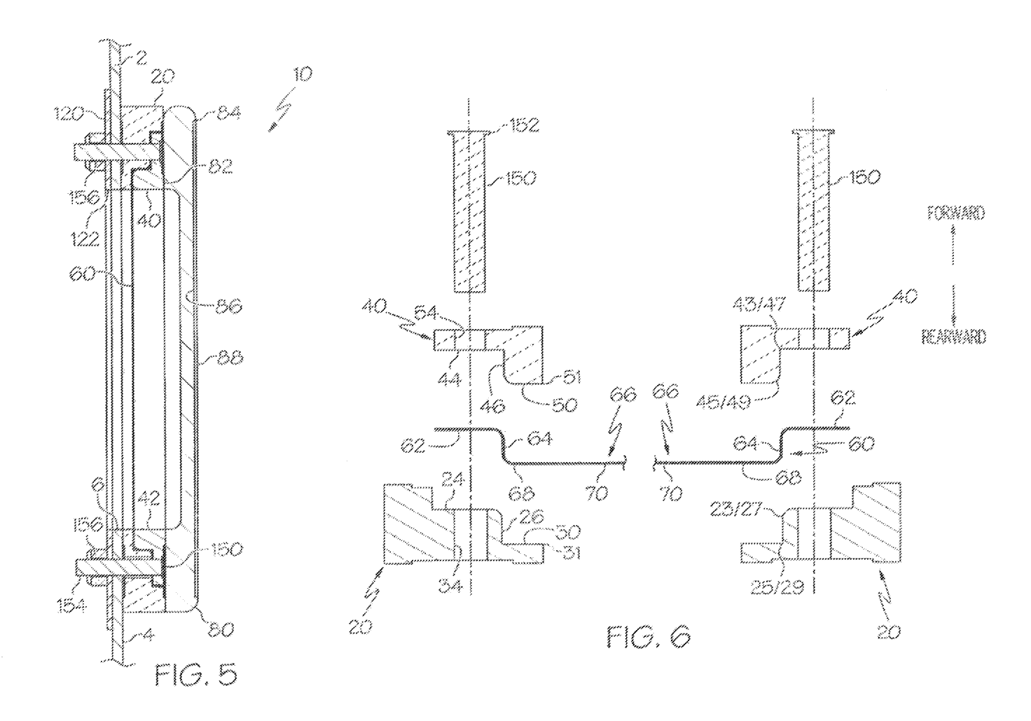

The observation window 10 can include fasteners 150 to join the retaining bezel 40 to the frame 20, with each of the fasteners 150 passing through holes in an outer flange portion of the optical pane 60. As shown in FIGS. 1 and 5-7B, the fasteners 150 can be studs that engage with apertures 54 in the retaining bezel 40 and extend through apertures 34 in the frame 20. Referring in particular to FIG. 7B for one example, a fastener 150 can include a flange 152, and can be sized to engage with the aperture 54 of the retaining bezel 40 with an interference fit. An inward end 154 of the fastener 150 can be provided with threads (not shown). Referring also to FIG. 5, when the observation window 10 is installed in wall 2, such as a panel wall, each inward end 154 of each fastener 150 can extend through the outer flange portion 62 of the observation window 60, through the frame 20, through the wall 2, and through the backing plate 120. Nuts 156 can engage with the threads of each of the fastener 150 to secure the observation window 10 to the wall 2, and to clamp the optical parse 60 within the stepped labyrinth cavity between the frame 20 and the retaining bezel 40. The step of the labyrinth cavity defined by frame step 26 and bezel step 46 can be substantially perpendicular to the forward and rearward surfaces of the frame 20 and retaining bezel 40, or the step may be at an angle other than perpendicular to such surfaces.

Passing each of the fasteners 150 through the flange 62 of the optical pane 60 contributes to strength of the optical pane 60 within the frame 20 and retaining bezel 40. It will be apparent to people of ordinary skill in this art that other arrangements of fasteners could additionally or alternatively be used. Dowel pins could additionally or alternatively be used to accomplish the same result. Although examples Including a stepped labyrinth, structure, retaining ridges and beads have been shown and described, it should be noted that the stepped labyrinth structure can be omitted and that the optical pane 60 can simply be secured by fasteners.

The wall 2 can include a generally planar region 3 that includes an outer surface 4, an inner surface 3, and a through opening 6. The window 10 can further include the backing plate 120 that can include a plate opening 122. The backing plate 120 can be joined to the frame 20 such that the wall 2 can be disposed between the frame 20 and the backing plate 120, with the plate opening 122 of the backing plate 120, the through opening 6 of the wall 2, the frame central opening 32 of the frame 20, and the bezel opening 52 of the retaining bezel 40 all being generally or substantially aligned with each other. The gasket 130 can be disposed between the frame 20 and the backing plate 120, and contacted with one of the outer surface 4 and the inner surface of the wall 2.

Components of the observation window 10 that do not have to be transparent can be formed from a variety of suitable materials depending on a specific application or use. For example, these components can be constructed from metals such as aluminum, steel, or a variety of other suitable metals or alloys, plastics such as polymers and polycarbonates, among other types of plastics, ceramics, or other suitable materials.

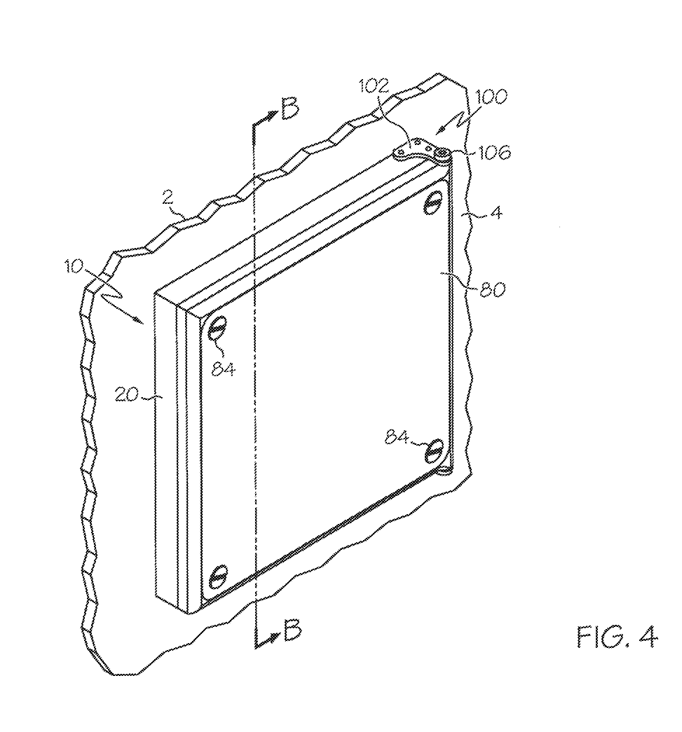

The observation window 10 can include a cover 80 that can be joined to the frame. In a fitted position (FIGS. 4 and 5), the cover 80 can protect the transparent central portion 66 of the optical pane 60. A gasket 140 (FIG. 1) can be disposed between the cover 80 and the retainer bezel 40. The cover 80 can be joined to the frame by hinges 100. In this configuration, the observation window 10 can include a means of opening the window cover 80, while also providing for a means fastening the window cover 80 to the window frame 20 and retaining bezel 40 to obtain a seal.

The hinges can be provided as “floating binges,” wherein the hinge mechanism 100 can enable the window cover to “float” relative to the window frame 20. In such an example, the hinge mechanism 100 can includes a bracket 102 that can be joined to the window frame 20 with suitable fasteners 104. The bracket 102 can extend outwardly from the frame 20, and can be constructed to include a generally oblong hole that can receive the hinge posts or fasteners 106 that can be attached to the window cover 80. The floating hinge 100 can enable the window cover 80 to be opened and closed. The window cover 80 can be secured against the retaining bezel 40 and frame 20 by fasteners 84, which cart be captive fasteners to retain them with the cover 80 when the cover 80 is in the open position. In one example, the hinge mechanisms 100 are made of stainless steel. The gaskets 130 and 140 can be made of a variety of pliable materials, such as neoprene, silicone, other suitable elastomers, or another suitable material.

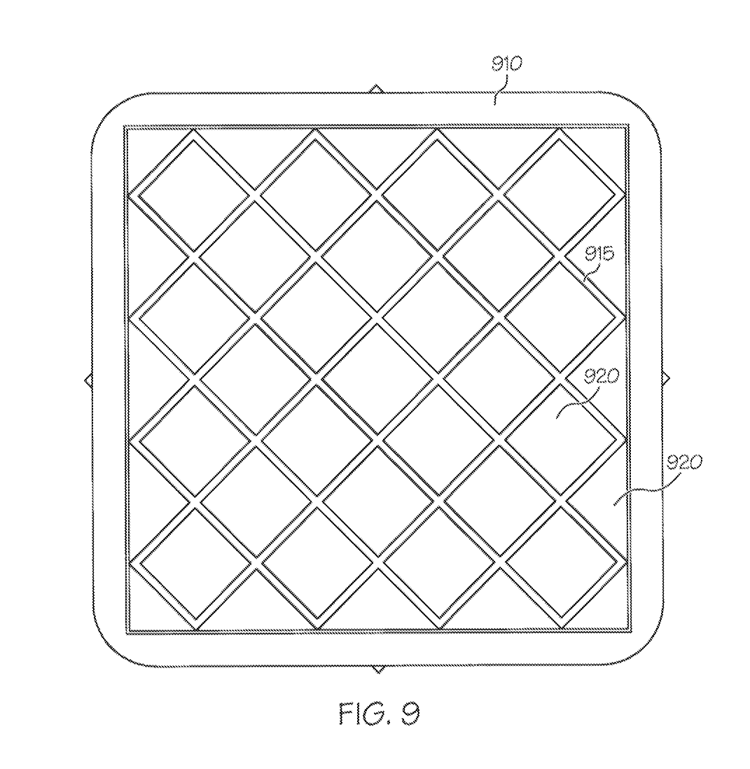

FIG. 8 is an exploded, cross-sectional view of the optical pane 60, the frame 20, and the retaining bezel 40 along with fasteners 810 and safety guards 910 (as further described below). The optical pane 60 can include a first retention region 820 and a second retention region 830. Each of these retention regions 820, 830 can be secured In place by the frame 20, the retaining bezel 40, and the fasteners 810. Specifically, the frame 20 can include a first pane support surface 840 and a second pane support surface 850. A first side of the first retention region 820 can abut the first pane support surface 840. The first side of the second retention region 830 can abut the second pane support surface 850. A first retaining surface 860 can abut a second side of the first retention region 820. A second retaining surface 870 can abut the second side of the second retention region 830. The optical pane 60, the frame 20, and the retaining bezel 40 can be held together by friction. Additionally or alternatively, optical pane 60, the frame 20, and the retaining bezel 40 can be held together by one or more fasteners 810 that can pass through openings 880, 885, and 890 of the frame 20, retaining bezel 40, and optical pane 60, respectively. The fasteners 810 can be threaded bolts, in which case one or both of the passages 880, 885 can be threaded or can be secured by nuts (not shown), can be rivets, or can be another suitable type of fastener. These components can also be secured by bonding methods such as gluing or welding, for example and as appropriate. Examples can include the safety guard 910 positioned on either side of the optical pane 60. Additionally or alternatively, safety guards 910 can be positioned on both sides of the optical pane 910. Recesses can be provided in the frame 20, the retaining bezel 40, or both so that the safety guard 910 can be flush with other surfaces.

FIG. 9 is a plan view of a safety guard 910. The safety guard 910 can serve as a protective measure to prevent a human body part, such as a finger or band, among others, from entering an area into which the inspection window provides a view. The safety guard 910 can be constructed out of a rigid material, such as stainless steel. A grid 915 can be formed with openings 920 that are sized small enough to prevent passage of a human body part such as a finger, but large enough to provide a relatively unobstructed view, or at least a usable view through the optical pane 60 without requiring removal of the safety guard 910. Although a checkerboard-style grid is shown, it should be noted that other types of grids, including grids with other opening shapes, can be used.

The above descriptions of various devices and methods are intended to illustrate specific examples and describe certain ways of making and using the devices disclosed and described here. These descriptions are neither intended to be nor should be taken as an exhaustive list of the possible ways in which these devices and components of these devices can be made and used. A number of modifications, including deletions from examples (for example, the observation window without a hinged door), substitutions of components between or among examples and variations among combinations can be made. Those modifications and variations will be apparent to those of ordinary skill in this area after having read this document.

We claim:

1. An apparatus, comprising:
an optical pane that is transparent to infrared radiation and including
first and second sides,
a periphery, and
first and second retention regions positioned near the periphery of the optical pane;
a flame that defines an opening that can accept the optical pane and that includes a pane retention region, the pane retention region including
a first pane support surface configured to support the optical pane at the first side of the first retention region and
a second pane support surface configured to support the optical pane at the first side of the second retention region; and
a retaining bezel that is configured to secure the optical pane in the opening and that includes
a first retaining surface mated to the first pane support surface of the frame and configured to support the optical pane at the second side of the first retention region, and
a second retaining surface mated to the second pane support surface of the frame and configured to support the optical pane at the second side of the second retention region.

2. The apparatus of claim 1, further comprising a movable cover configured to prevent access to the optical pane in a closed position and permit access to the optical pane in an open position.

3. An apparatus according to any one of claims 1-2, wherein the cover is movably attached to the frame by a hinge.

4. The apparatus of claim 3, wherein the hinge is a floating hinge.

5. An apparatus according to any one of claims 2-4, further comprising retaining bolts configured to secure the cover in the closed position.

6. An apparatus according to any one of claims 1-5, further comprising a guard configured to prevent passage of a human body part through the opening of the frame.

7. An apparatus according to any one of claims 1-6, wherein the optical pane is formed from polyethylene.

8. An apparatus according to any one of claims 1-7, wherein the optical pane is formed from a crystalline material.

9. An apparatus according to any one of claims 1-8, wherein the optical pane is formed from a material that is transparent to infrared radiation selected from the group consisting of high-density polyethylene, calcium fluoride, barium fluoride, zinc selenide, and silica glass.

10. The apparatus of claim 9, wherein the infrared radiation has a wavelength in the range of about 1 micron to about 5 microns.

11. The apparatus of claim 9, wherein the infrared radiation has a wavelength in the range of about 1.4 micron to about 3 microns.

12. The apparatus of claim 9, wherein the infrared radiation has a wavelength in the range of about 8 microns to about 14 microns.
